(19) United States
(12) Patent Application Publication
(10) Pub. No.: US 2014/0134521 A1
(43) Pub. Date: May 15, 2014

(54) CARBON MATERIAL, METHOD OF MANUFACTURING THE SAME, AND ELECTROCHEMICAL CELL USING THE SAME

(71) Applicant: Kabushiki Kaisha Toshiba, Minato-ku (JP)

(72) Inventors: Katsuyuki NAITO, Tokyo (JP); Norihiro YOSHINAGA, Kanagawa (JP); Shigeru MATAKE, Kanagawa (JP); Yoshihiro AKASAKA, Kanagawa (JP)

(73) Assignee: Kabushiki Kaisha Toshiba, Minato-ku (JP)

(21) Appl. No.: 14/077,802

(22) Filed: Nov. 12, 2013

(30) Foreign Application Priority Data
Nov. 14, 2012 (JP) 2012-250619
Nov. 8, 2013 (JP) 2013-232600

(51) Int. Cl. H01M 4/36

(52) U.S. Cl. CPC H01M 4/366
USPC 429/523; 252/182.1; 429/231.8; 429/221; 429/224; 204/242

(57) ABSTRACT

A carbon material of an embodiment includes: a columnar structure in which a carbon compound having a graphene skeleton is laminated, the graphene skeleton whose some of carbon atoms are substituted with nitrogen atoms. In the carbon material, a graphene skeleton surface of the carbon compound is inclined at an angle of 5 degrees or more and 80 degrees or less with respect to a column axial direction of the columnar structure.

### CROSS-REFERENCE TO RELATED APPLICATION

This application is based upon and claims the benefit of priority from Japanese Patent Applications No. 2012-250619 filed on Nov. 14, 2012 and No 2013-232600 filed on Nov. 8, 2013; the entire contents of which are incorporated herein by reference.

### FIELD

Embodiments described herein relate generally to a carbon material, a method of manufacturing the same, and an electrochemical cell using the same.

### BACKGROUND

In the related art, the fact that carbon materials whose some of carbon atoms are substituted with nitrogen atoms and used as an oxygen reduction catalyst of a fuel cell is well known. Among the carbon materials, a carbon catalyst, in which carbon particles of a nano-shell structure are at least partially contained to be formed in a fibrous shape, is well known. The fibrous shape is advantageous to the diffusion of a fuel gas or water to be produced. However, since the carbon catalyst having the fibrous shape of the related art is small in an activation point, there is a problem in that the drawing of sufficient current is difficult.

### BRIEF DESCRIPTION OF THE DRAWINGS

FIG. 1 is a conceptual diagram of a carbon material according to an embodiment;

FIG. 2 is an enlarged conceptual diagram of the carbon material according to the embodiment;

FIG. 3 is a schematic diagram including an atomic structure of the carbon material according to the embodiment;

FIG. 4 is a conceptual diagram of an electrochemical cell in which the carbon material according to the embodiment is used in a positive electrode or a negative electrode;

FIG. 5 is a conceptual diagram of an oxygen decreasing apparatus according to the embodiment;

FIG. 6 is a conceptual diagram of a refrigerator according to the embodiment;

FIG. 7 is an image of a carbon material according to Example 1 photographed by a scanning electron microscope (SEM);

FIG. 8 is an image of the carbon material according to Example 1 photographed by a transmission electron microscope (TEM);

FIG. 9 is an image of another place in the carbon material according to Example 1 photographed by the transmission electron microscope (TEM);

FIG. 10 is a high-magnification image of the carbon material according to Example 1 photographed by the transmission electron microscope (TEM);

FIG. 11 is a high-magnification image of another place in the carbon material according to Example 1 photographed by the transmission electron microscope (TEM);

FIG. 12 is a high-magnification image of further another place in the carbon material according to Example 1 photographed by the transmission electron microscope (TEM);

FIG. 13 is a schematic diagram of an apparatus for examining an oxygen reduction activity of the carbon material;

FIG. 14 is a graph illustrating measurement curves of the oxygen reduction activity of the carbon material according to Example 1 and Comparative Example 1; and

FIG. 15 is an image of the carbon material according to Comparative Example 1 photographed by the scanning electron microscope (SEM).

### DETAILED DESCRIPTION

A carbon material of an embodiment includes: a columnar structure in which a carbon compound having a graphene skeleton is laminated, the graphene skeleton whose some carbon atoms are substituted with nitrogen atoms. In the carbon material, a graphene skeleton surface of the carbon compound is inclined at an angle of 5 degrees or more and 80 degrees or less with respect to a column axial direction of the columnar structure.

A method of manufacturing a carbon material of an embodiment includes: dissolving the metal particle which is contained in a carbon fiber having a structure in which graphene surfaces are overlapped; and substituting some of carbon atoms with nitrogen atoms after the dissolving of the metal particle.

An electrochemical cell of an embodiment includes: a positive electrode; a negative electrode; and an electrolyte configured to be sandwiched between the positive electrode and the negative electrode. In the electrochemical cell, the positive electrode or the negative electrode contains a carbon material, which includes a columnar structure in which a carbon compound having a graphene skeleton is laminated, the graphene skeleton whose some of carbon atoms is substituted with nitrogen atoms. Furthermore, a graphene skeleton surface of the carbon compound is inclined at an angle of 5 degrees or more and 80 degrees or less with respect to a column axial direction of the columnar structure.

Embodiments will be described below with reference to the drawings.

Hereinafter, embodiments will be described with reference to the accompanying drawings as necessary. A carbon material of an embodiment includes: a carbon fiber having a columnar structure in which a carbon compound having a graphene skeleton is laminated, the graphene skeleton whose some of carbon atoms are substituted with nitrogen atoms. In the carbon material, a graphene skeleton surface of the carbon compound is preferably inclined at an angle of 5 degrees or more and 80 degrees or less with respect to a column axial direction of the columnar structure.

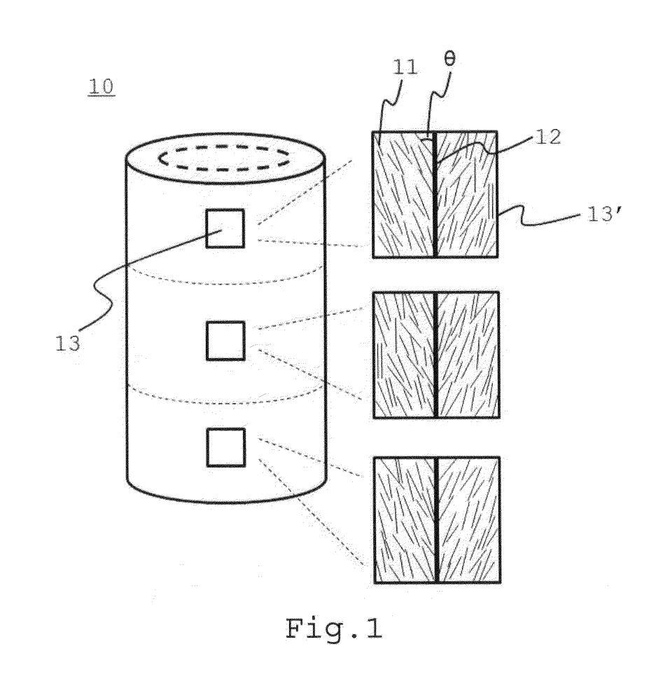

As illustrated in a conceptual diagram of FIG. 1, a carbon material 10 according to the present embodiment has a columnar structure 10 in which a carbon compound 11 is densely laminated. At least some of carbon compounds are formed in such a manner that some of carbon atoms of a graphene skeleton are substituted with nitrogen atoms or the carbon atoms are bonded to oxygen atoms. Reference numeral 13′ denotes a conceptual diagram in which a lateral region 13 of the columnar structure is enlarged. A graphene skeleton surface (hereinafter, abbreviated to as a “graphene surface”) of the carbon compound 11 of the lateral region 13′ having the columnar structure is characterized by having a graphene surface which is inclined in a distributed state of 5 degrees or more and 80 degrees or less with respect to a column axial direction 12. Hereinafter, the graphene surface is also denoted as a reference numeral 11. The graphene surface is a segment of reference numeral 11 in the conceptual diagram of FIG. 1, and an angle to the graphene surface of the column axial direction 12 may be obtained from an angle to the segment and the column axis. An example of a member having the columnar structure 10 may include a carbon fiber.

In the carbon material including the columnar structure, substances such as oxygen, hydrogen, or water can be easily diffused through the carbon material, and thus the operation can be performed at a high current. In general, a tubular carbon fiber is formed such that the graphene surface is approximately parallel to and approximately symmetrical to the column axis, but the carbon fiber according to the embodiment is formed such that the graphene surface 11 is inclined to the column axis. When the graphene surface is inclined at an angle of 5 degrees or more and 80 degrees or less with respect to the column axial direction 12, many active graphene edges exist in the end of the columnar structure 10, a contact area between the graphene surfaces 11 increase, and thus the columnar structure can be stably maintained. When the inclined angle of the graphene surface is larger than 80 degrees, the contact area of the graphene becomes small, and thus the columnar structure becomes unstable to be easily broken. In addition, when the inclined angle of the graphene surface is smaller than 5 degrees, the active graphene edge becomes few. More preferably, the inclined angle of the graphene surface is the angle of 10 degrees or more and 60 degrees or less.

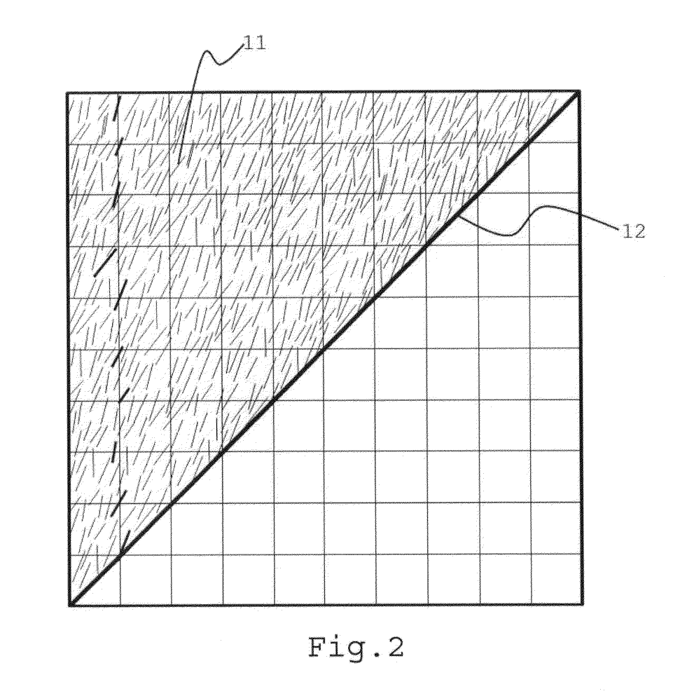

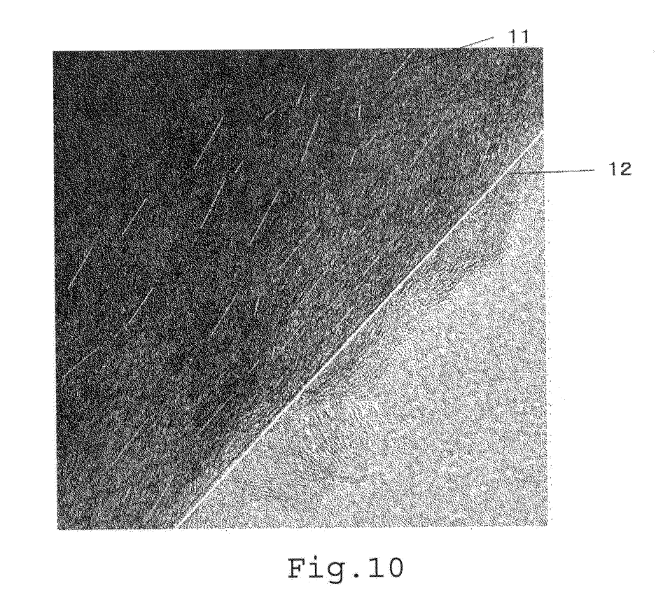

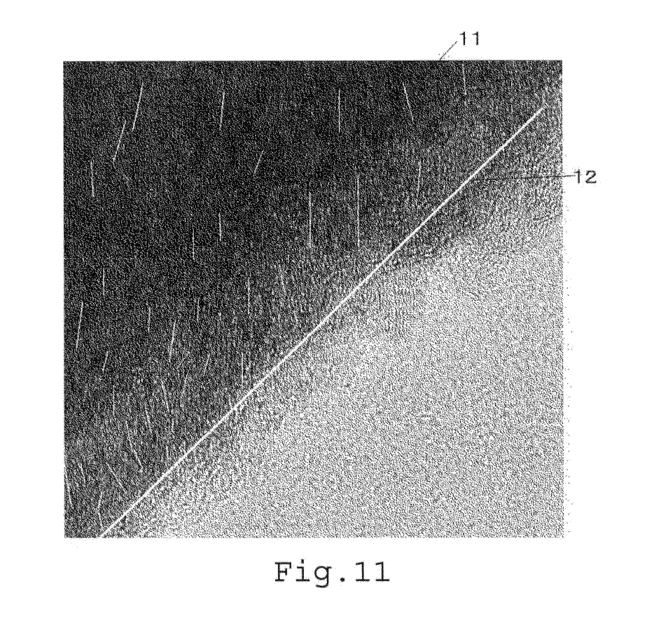

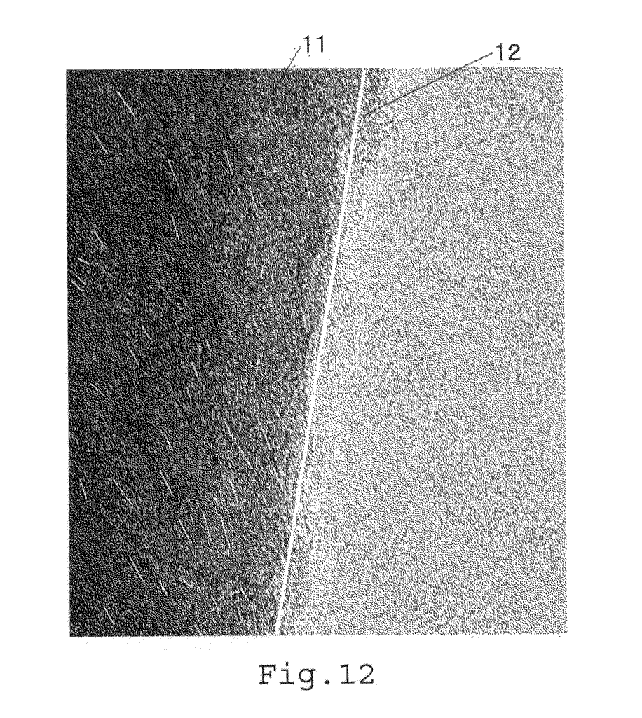

The inclination of the columnar-side graphene surface 11 to the column axial direction 12 can be observed in detail according to following manners, for example. The inclination of the graphene surface 11, in which the column axial direction 12 is imaged on a central portion, can be photographed to confirm by magnifying to four million times using a transmission electron microscope (TEM). In a TEM image having the columnar structure, a dark color becomes gradually darker from a region without the carbon compound to the surface and inside of the columnar carbon compound. Therefore, even when the graphene structure of the columnar outermost surface is disturbed, the column axial direction 12 can be specified from the photographed image by changes in shading as illustrated in FIGS. 10 to 12. In addition, the inclination of the graphene surface 11 can be confirmed by identifying the column axial direction from a lower-magnification image and comparing the identified column axial direction with the column axial direction obtained from the changes in shading described above. Here, lattice layers of 10×10 squares are superimposed to a photographed image as illustrated in an enlarged conceptual diagram of the carbon material of FIG. 2, and thus an angle between the graphene surface 11, which overlaps intersections between lines of the lattice or is nearest from the intersections, and the column axial direction 12 is measured. The angle formed between the graphene surface 11 and the column axial direction 12 may be measured by converting the image photographed by the TEM as illustrated in the conceptual diagram of FIG. 2. In FIG. 2, the column axial direction 12 is indicated by a thick line toward the lower left from the upper right, and the graphene surface 11 is indicated by a thin line. Moreover, a part of the graphene surface 11 of an angle measurement object is indicated by the thick line in FIG. 2. In places where differences in measurement or the graphene are not recognized, it may not be necessary to perform the measurement of the angle. In addition, as illustrated in the conceptual diagram of FIG. 1, a photographing position is preferably located at a central part of three equal parts which are obtained by trisecting the carbon fiber in a longitudinal direction. At this time, the photographing is preferably performed at a position where the central points of photographing regions can be connected to each other with one straight line. Preferably, at least 5% or more and 95% or less of the angle of the graphene surface 11 to the column axial direction 12 measured in each region satisfies the angle range of 5 degrees or more and 80 degrees or less, more preferably 10 degrees or more and 60 degrees or less. When the graphene surface 11 satisfying the angle range is too small, it is not preferable that the graphene edge become few. Accordingly, the graphene surface 11 satisfying the angle range is more preferably not less than 40%. In addition, when the graphene surface 11 satisfying the angle range is too large, it is unfavorable that the stability of the columnar structure of the carbon fiber may be reduced. Accordingly, more preferably, the graphene surface 11 satisfying the angle range is not more than 90%.

A diameter of the columnar structure 10 of the carbon material according to the present embodiment is preferably 30 to 500 nm. When the diameter is less than 30 nm, a diffusion of a substance, which reacts using the carbon material as a catalyst, is inhibited. When the diameter is more than 500 nm, an activation point becomes smaller. More preferably, the diameter is from 100 nm to 300 nm. A length of the column axial direction 12 of the carbon material is preferably 1 μm or more and 10 μm or less.

From a viewpoint of an increase of the activation point of the catalyst and excellence in diffusion property of the material, an end of the columnar structure 10 according to the present embodiment is preferably opened, and a recess is preferably formed at the end. The recess of the columnar structure 10 can be confirmed using the TEM image.

In addition, the carbon compound 11 of the columnar structure 10 according to the present embodiment preferably has a densely overlapped structure. The laminated state, which is densely overlapped, indicates a state in which an area occupied by the graphene surface 11 is 50% or more in the region capable of confirming the graphene surface 11 through the TEM image in which the columnar structure 11 or the carbon fiber is magnified to four million times and at least 50% or more of the graphene surface 11 is overlapped with another graphene surface 11. When the graphenes are in the densely overlapped state, there is an advantage in that the structure is stabilized.

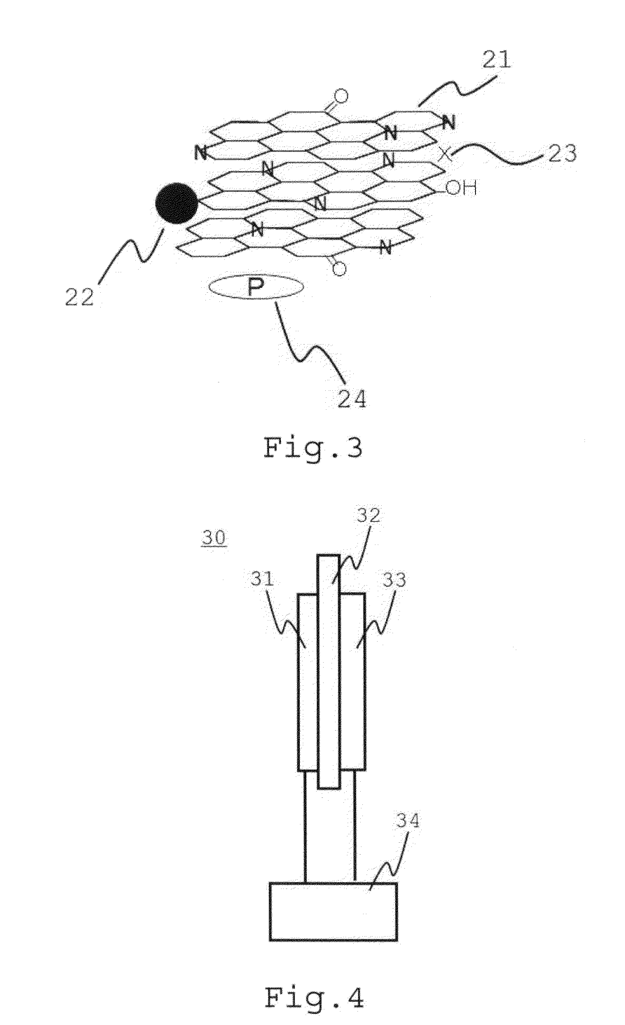

FIG. 3 is a schematic diagram illustrating an example of an atomic structure of the carbon compound 11 and a metal included in the carbon material. Some of carbon atoms of a graphene skeleton 21 are substituted with nitrogen atoms. In addition, some of carbon atoms of the graphene skeleton 21 may be bonded to oxygen atoms. The carbon material may also contain a metal particle 22, a metal ion 23, a phosphorus compound 24 or the like in some cases. The carbon compound 11 may also contain an un-substituted compound.

The nitrogen atoms are substituted for some of carbon atoms of the graphene skeleton 21 of the carbon compound 11. A substitution form of the nitrogen atoms is classified into a quaternary nitrogen, a pyridine nitrogen, a pyrrole.pyridine nitrogen, and an oxygen-bonded nitrogen.

The amount of the carbon atoms substituted with the nitrogen atoms is preferable that the nitrogen atoms be 0.1 atom % or more and 30 atom % or less with respect to the carbon atoms. When the substituted amount of nitrogen is less than the lower-limit value, catalytic activity unfavorably decreases. In addition, when the substituted amount of nitrogen is more than the upper-limit value, since the graphene structure is disturbed, electrical resistance unfavorably increases. More preferably, the nitrogen atoms are 3 atom % or more and 20 atom % or less with respect to the carbon atoms.

The oxygen atoms are bonded to some of carbon atoms of the graphene skeleton 21 of the carbon compound 11. When the oxygen atoms are contained in the graphene skeleton 21, the influence of long-term degradation due to oxygen molecules can be reduced after manufacturing an oxygen reduction catalyst. Bonding types of the oxygen atom with the carbon atom include an ether type, a ketone type, an alcohol type, a phenol type, or a carboxylic acid type. In addition, the oxygen atom is included in the phosphorus compound and may be included in the carbon material as a metal oxide in some cases.

The introduced amount of oxygen atoms is preferable that the oxygen atoms have 5 atom % or more and 100 atom % or less with respect to the carbon atoms. When the introduced amount of the oxygen atoms is less than the lower-limit value, the variation of the catalytic activity increases with respect to oxygen. In addition, when the introduced amount of the oxygen atoms is more than the upper-limit value, the electrical resistance increases, the affinity for water increases, and thus the inhibition of the air diffusion called a flooding phenomenon easily occurs.

The carbon material according to the present embodiment may include the metal particle 22 or the metal ion 23. In this case, the metal preferably includes one or more elements selected from iron, cobalt, or manganese. For example, the size of the metal particle is 1 nm or more and 10 nm or less. When the carbon material includes the metal particle or metal ion, since graphitization is more likely to proceed during a preparation of the oxygen reduction catalyst, durability of the oxygen reduction catalyst further increases. In addition, the catalytic activity increases more than an electronic interaction between the metal and the graphene. The amount of the metal atoms preferably is 1 atom % or less of the carbon atoms. When the amount of the metal atoms is more than 1 atom %, the metal ion is incorporated in an electrolyte membrane, and thus there is a higher possibility that a charge transfer is inhibited.

The carbon material according to the present embodiment may include platinum particles. In the case of using the platinum particles, the carbon material according to the embodiment becomes a carrier of platinum. For example, the size of platinum particles is 1 nm to 10 nm which may be a particle diameter to be used as a general oxygen reduction catalyst. Since the nitrogen atoms are substituted, the size of platinum particles can be reduced, and since the graphene edges acting as the adsorption site of the platinum particles are large, desorption can be avoided. When 0.1 wt % or more of the platinum are added to the carbon material, the activity can be increased even in very small amounts. In addition, since the oxygen is previously introduced into the carbon material to suppress the carbon corrosion, it is possible to further prevent the desorption of the platinum from the carrier, thereby suppressing the amount of platinum to be used.

Examples of a phosphorus compound 24 contained in the carbon material according to the embodiment include one or more of monophosphate, origophosphate, or polyphosphoric acid. The phosphorus compound is contained internally or externally in the carbon fiber. A radical is trapped by the presence of the phosphorus compound, and thus deterioration of the carbon material is preferably prevented. The presence of the phosphorus compound can be recognized by a peak of electron emission energy of 2 p orbit such as 132.0 to 133.0 eV due to the origophosphate, 132.6 to 133.3 eV due to pyrophosphate as an origophosphate obtained by two-molecular condensation of orthophosphoric acid, or 134.0 to 134.5 eV due to polyphosphate, which are analyzed by XPS.

The amount of each atom contained in the carbon material can be measured using an X-ray photoelectron spectroscopy (XPS). For example, the XPS measurement conditions are as follows: XPS apparatus—Quantum-2000 manufactured by PHI; X-ray source—monocrystal spectrum AlKα ray; power—40 W; analysis region—diameter of 200 μm; path energy—Wide Scan—187.85 eV (1.60 eV/Step), Narrow Scan—58.70 eV (0.125 eV/Step); charge neutralization gun—Ar⁺, e⁻; and geometry—θ=45° (θ: angle between a sample surface and a detector). In order to prevent the charge-up, a measurement sample is prepared to be electrically conducted using a conductive tape as necessary.

Next, a method of manufacturing the carbon material according to the present embodiment will be described.

Preferably, the method of manufacturing the carbon material according to the embodiment includes a process of dissolving the metal particles contained in the carbon fiber having the structure in which the graphene surfaces are densely overlapped and a process of substituting some of the carbon atoms with the nitrogen atoms after the dissolving process.

Then, the process of substituting the some of the carbon atoms with the nitrogen atoms is preferably carried out by performing oxidation treatment on the carbon fiber with an acidic solution containing potassium permanganate, after the oxidation treatment, treating the carbon fiber using hydrazine or ammonia, and heating the carbon fiber. The metal particle is dissolved at the time of the oxidation treatment.

In the order that the carbon fiber having the structure in which the graphene surface 11 is densely overlapped contains the metal particles, the carbon fiber is preferably manufactured by a CVD (Chemical Vapor Deposition) in such a manner that a methane gas, a hydrogen gas, or an argon gas is supplied using the metal particles as a catalyst. Iron, cobalt, or nickel is preferred as the metal particle, and the iron is more preferable. The diameter of the metal particle is preferably 30 nm or more and 500 nm or less. The diameter of the carbon fiber can be controlled by the diameter of the metal particle. When the diameter of the metal particle is too small, a carbon nanotube will be manufactured. Moreover, when the diameter of the metal particle is too large, it is unfavorably difficult to control the diameter of the metal particle.

The process of substituting the some of the carbon atoms with the nitrogen atoms is preferably performed by oxidizing the carbon atoms of the carbon fiber with potassium permanganate and then treating the carbon fiber with the hydrazine or the ammonia. The oxidation of the carbon atoms with the potassium permanganate is preferably performed by adding the potassium permanganate to the acid solution. Suitable acid concentration, treatment time, and treatment temperature will vary depending on each condition. An example of the suitable condition includes a mixture of 1 mol of a sulfuric acid, 0.02 mol of a nitric acid, and 0.05 mol of a potassium permanganate, and the oxidation treatment of the carbon fiber may be performed by gradually raising the temperature from 0° C. At this time, the metal particles are also dissolved. After the treatment with the potassium permanganate, it is preferable to perform the treatment with the hydrazine or the ammonia. The treatment with the hydrazine or the ammonia includes a treatment for heating at 70° C. or more and 150° C. or less (about 80° C.) for about one hour in a vapor phase or by spraying or applying the hydrazine or the ammonia on an oxide or a treatment for heating by adding the hydrazine or the ammonia to an aqueous dispersion of the oxide. In addition, it may include a combination of these treatments. It is preferable to treat these at a high temperature of 400° C. to 1100° C. It is more preferably to treat them at a temperature of 700° C. to 900° C. More preferably, it is treated at the high temperature with a gas containing the ammonia. In the case in which a large amount of oxygen atoms are contained in a raw material, it is preferable to contain hydrogen capable of controlling an appropriate amount of oxygen. After this process, the bonding between the carbon atoms of the carbon fiber is broken by the oxidation treatment, and a recess occurs in the end of the broken carbon fiber.

In addition, nitrogen-containing polymers, nitrogen-containing metal compounds, or phosphorus compounds may be contained during the high-temperature treatment of 400° C. to 1100° C. A mixture of these compounds and the hydrazine-treated material may be treated at a high temperature. A metal contained therein may exist in the carbon material as a metal ion. Examples of the nitrogen-containing polymers include, for example, a melamine resin, a guanamine resin, a benzoguanamine resin, a urea resin, polyacrylonitrile, polyaniline, or polyphenylene diamine. A compound of iron or cobalt is preferred as the nitrogen-containing metal compound and includes, for example, iron phthalocyanine, cobalt phthalocyanine, iron porphyrin, or cobalt porphyrin. The metal compound may be mixed with a material to be sintered. Examples of the metal compounds include, for example, iron sulfate, cobalt sulfate, iron chloride, or cobalt chloride. Examples of the phosphorus compounds include triphenylphosphine, phosphazene derivatives, phosphoric acid, or polyphosphoric acid.

The carbon material is dispersed in an aqueous platinum chloride solution, the platinum nanoparticles are generated by reducing a platinum ion with a reducing agent such as sodium borohydride, and the generated platinum nanoparticles are introduced into the carbon material.

The carbon material according to the embodiment is preferably used in an electrochemical cell. FIG. 4 is a conceptual diagram illustrating a sectional structure of an electrochemical cell 30 according to the present embodiment. The electrochemical cell 30 includes a positive electrode 31, a negative electrode 33, and an electrolyte 32 which is sandwiched between the positive electrode 31 and the negative electrode 33. The positive electrode 31 and the negative electrode 33 are connected to an external electrical circuit 34. The carbon material as a highly active catalyst according to the embodiment is preferably contained in the positive electrode 31 or the negative electrode 33 to improve the performance of the electrochemical cell.

Preferably, the electrochemical cell according to the present embodiment is used in a fuel cell. The carbon material can be used in the oxygen reduction catalyst of the positive electrode or the carrier to provide a high-output fuel cell.

Preferably, the electrochemical cell according to the present embodiment is used for a lithium secondary battery containing the carbon material and silicon particles in the negative electrode. The silicon particles form a large-capacity secondary battery that takes in lithium ions, but the large-capacity secondary battery has a poor cycle characteristic. By the carbon material having the graphene substituted with nitrogen cell, the silicon particles can be stably maintained, and the cycle characteristic can be significantly improved. A silicon nanoparticle having a diameter of 2 nm to 300 nm is preferred as the silicon particle. In the sum of the carbon material and the silicon particles, the weight ratio of the carbon material is preferably 1% to 50%. More preferably, the weight ratio is 3% to 40%. A conductive assistant may be further contained in the negative electrode. The conductive assistant is a powder made of at least one kind of conductive material selected from the group consisting of carbon, copper, tin, zinc, nickel, and silver.

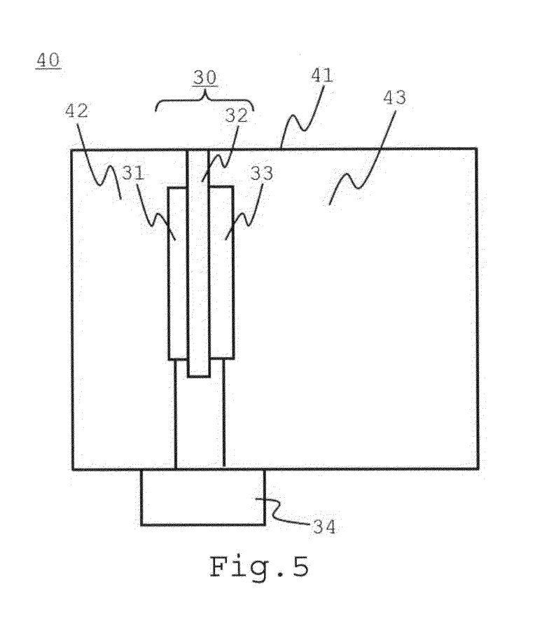

An example of a form having the electrochemical cell 30 according to the embodiment includes an oxygen decreasing apparatus. FIG. 5 is a conceptual diagram illustrating an oxygen decreasing apparatus 40 provided with the electrochemical cell 30 according to the embodiment. The oxygen decreasing apparatus 40 includes an electrochemical cell 30 and an oxygen decreasing container 41 which is partitioned by the electrochemical cell 30. A positive region 42 is provided at the positive electrode 31 side of the electrochemical cell 30, and a negative electrode chamber 43 is provided at the negative electrode 33 side of the electrochemical cell 30. The negative electrode chamber 43 can be in a decreased oxygen state by an electrolysis reaction of water at the positive electrode side and an oxygen reduction reaction at the negative electrode side in the electrochemical cell. The positive region 42 may be opened to an atmosphere. Furthermore, the oxygen decreasing apparatus 40 of FIG. 5 illustrates only a basic configuration, and an extraction door or a function of efficiently operating may be added in addition to the configuration illustrated in FIG. 5. It is possible to make an oxygen decreased state with high efficiency by employing an electrode provided with the highly active catalyst for an electrode of the oxygen decreasing apparatus 40. Something, in which the oxygen decreased state is preferred at the time of storing, is preferably kept in the negative electrode chamber 43.

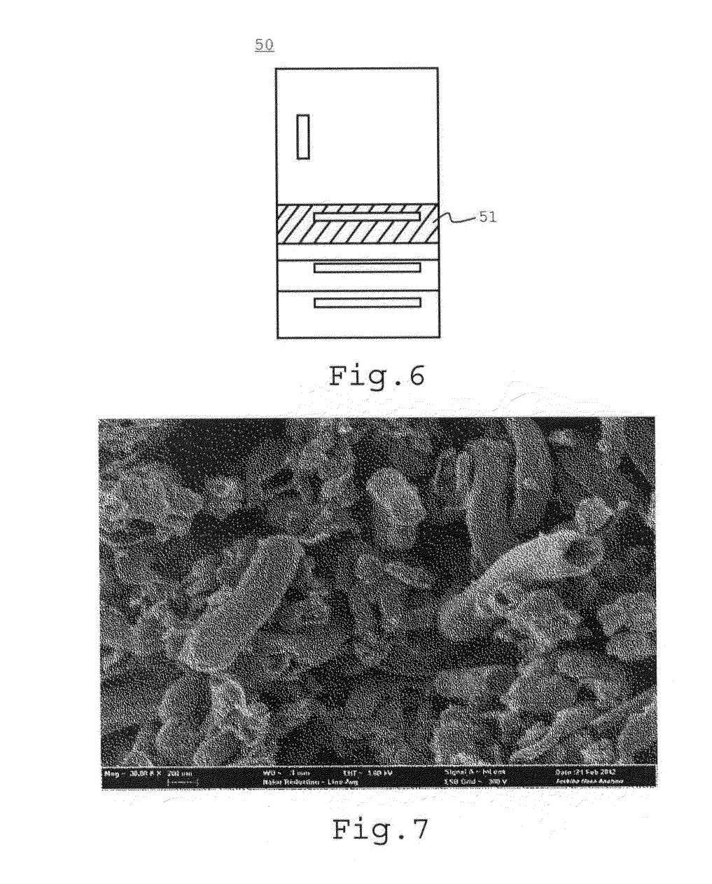

An example of a form having the oxygen decreasing apparatus according to the embodiment includes a refrigerator. FIG. 6 is a conceptual diagram illustrating the refrigerator having a refrigeration chamber 51 provided with the oxygen decreasing apparatus according to the embodiment. As the refrigeration chamber 51, for example, a vegetable chamber is preferred. Vegetables or fruits can be hardly decayed at the oxygen decreased state. An example of the electrochemical cell according to the embodiment includes a form to be used for oxygen concentration adjustment of the cell culture apparatus other than the refrigerator.

The embodiments described herein will be described below in detail by examples.

### EXAMPLE 1

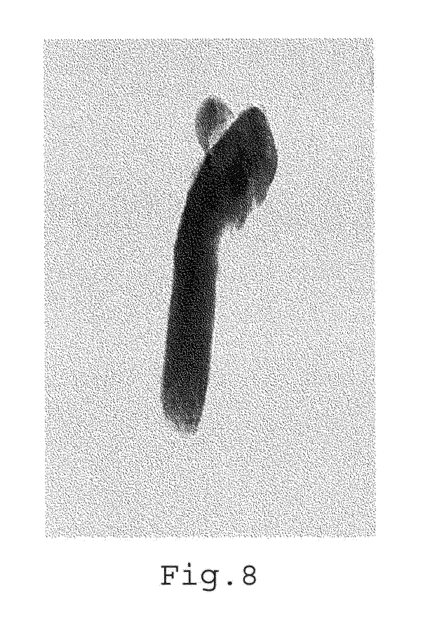

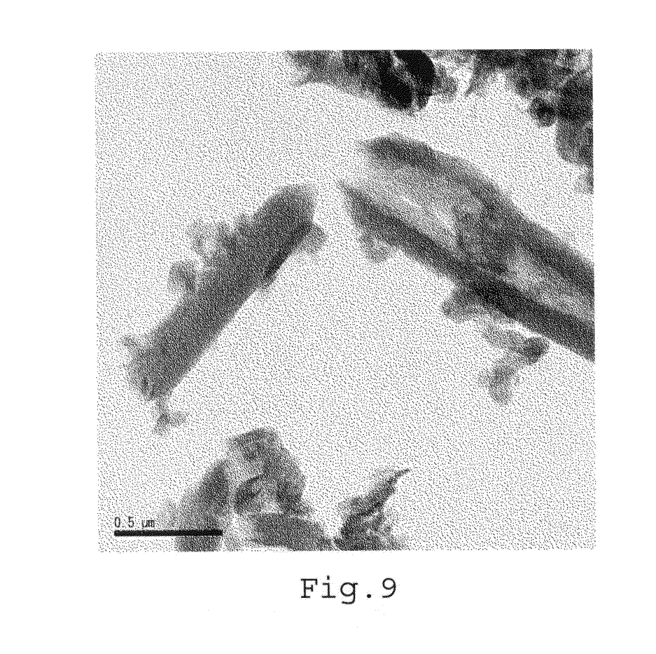

A carbon nano fiber having a diameter of 100 to 400 nm is produced by a thermal CVD under a flow of methane, hydrogen, or argon, using an iron microparticle having a diameter of 100 to 400 nm as a catalyst. Then, the carbon nano fiber is reacted to be oxidized in the presence of 0.04 mol of a potassium permanganate in a mixed solvent of 1 mol of a sulfuric acid and 0.15 mol of a nitric acid. The obtained oxide is heated and filtered in the aqueous hydrazine solution. The obtained powder is heated at 800° C. under the flow of argon, and then the carbon material is obtained. The number of nitrogen atoms, oxygen atoms, and manganese atoms, which are observed by the XPS measurement of the carbon material, is 4%, 3%, and 0.05%, respectively, with respect to the number of carbon atoms. FIG. 7 illustrates an image of the obtained carbon material photographed by a scanning electron microscope (SEM). In FIG. 7, a columnar structure is seen, and the recess is seen at the end of the columnar structure. In addition, FIGS. 8 and 9 illustrate images of the obtained carbon material photographed by a transmission electron microscope (TEM). The columnar structure or a coil-shaped columnar structure is seen.

FIGS. 10 to 12 illustrate high-magnification TEM images of the columnar structure 10. The graphene surface 11 is observed, and it is seen that the graphene surface on the columnar side 13 is inclined in the distributed state at an angle of 5 degrees or more and 80 degrees or less with respect to the column axial direction 12. To make it easy to understand, a white auxiliary line is illustrated in the TEM images.

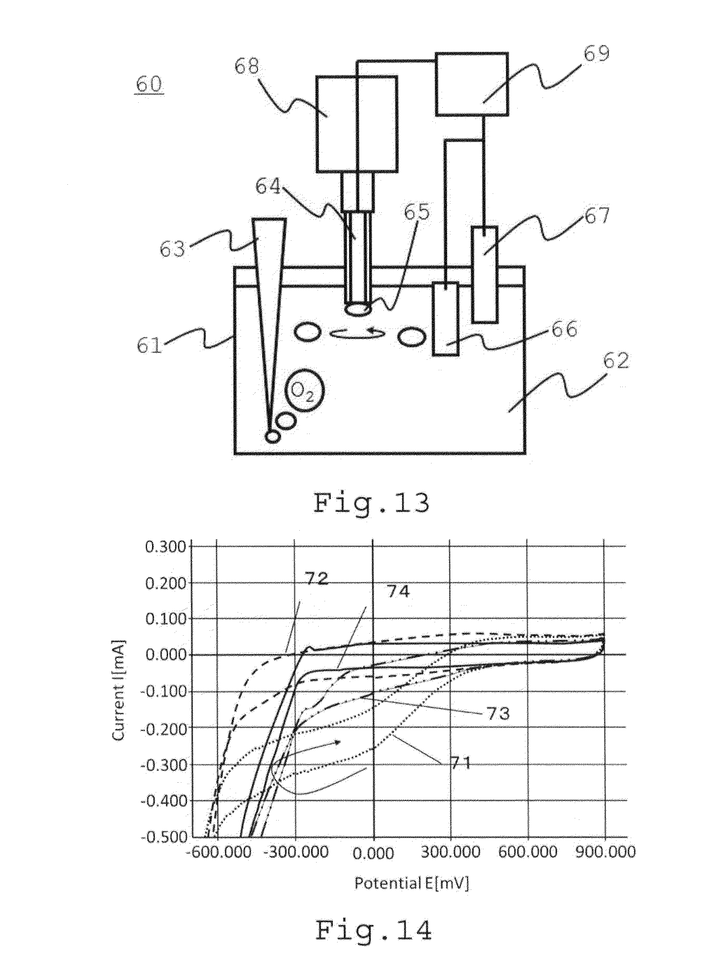

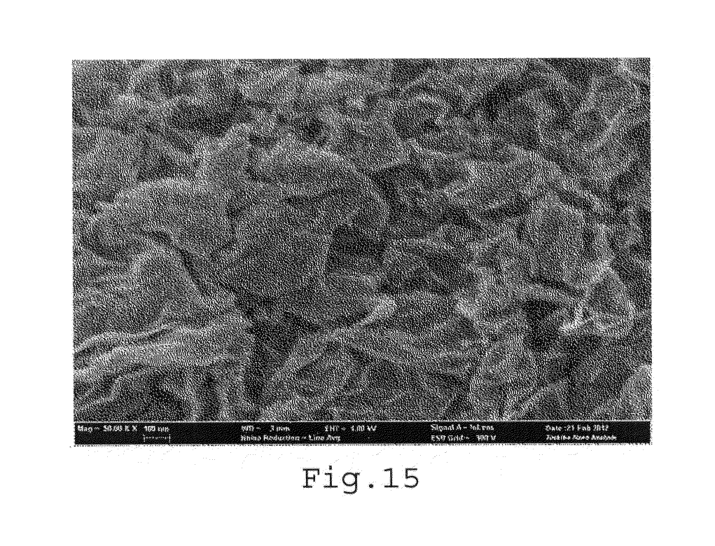

The obtained carbon material is dispersed in ethanol/water and is then applied on a rotary disk-shaped glassy carbon electrode to measure oxygen reduction activity using an apparatus illustrated in FIG. 13. The apparatus illustrated in FIG. 13 is an apparatus 60 which is configured to examine the oxygen reduction activity. The apparatus illustrated in FIG. 13 is made up of a flask 61, a sulfurin acid solution 62, an oxygen gas introducing portion 63, a rotary disk-shaped glassy carbon electrode 64, an oxygen reduction catalyst 65, a carbon counter electrode 66, a silver/silver chloride electrode 67, a motor 68, and a potentiostat 69 to measure the catalytic activity of the electrode according to the embodiment in oxygen. FIG. 14 is a graph in which results of Examples and Comparative Examples are summarized. In FIG. 14, as indicated by a measurement curve 71, a reduction current of 0.26 mA is observed in a sweep toward a negative potential at potential of 0 V (silver/silver chloride electrode served as a counter electrode), under an oxygen atmosphere with the catalytic amount of 0.07 mg at a motor rotation speed of 900 rpm, thus having a high activity. In FIG. 14, reference numeral 72 is a measurement curve obtained by measuring in the atmosphere of a nitrogen gas which is substituted for an oxygen gas 63.

### COMPARATIVE EXAMPLE 1

The carbon material is prepared in the same manner as in Example 1 except that graphite is used as a raw material instead of the carbon nano fiber. FIG. 15 illustrates an image of the scanning electron microscope (SEM) of the obtained carbon material. A form is an aggregate of a plate-like structure. The oxygen reduction activity of the obtained carbon material is measured in the same manner as in Example 1. In FIG. 14, as indicated by a measurement curve 73, only the reduction current of 0.1 mA is observed in the sweep toward the negative potential at potential of 0 V (silver/silver chloride electrode served as a counter electrode), under an oxygen atmosphere with the catalytic amount of 0.07 mg at a motor rotation speed of 900 rpm, thus having the high activity lower than that of Example 1. In FIG. 14, reference numeral 74 is a measurement curve in the atmosphere of the nitrogen gas which is substituted for the oxygen gas 63.

### COMPARATIVE EXAMPLE 2

The carbon material is prepared in the same manner as in

Example 1 except that the carbon nano fiber (multi-layered carbon nano tube) (graphene having the angle less than 5 degrees with respect to the column axis of the graphene surface is 80% or more of the photographing image surface), in which the graphene surface is substantially parallel to the column axial direction and which has a diameter of 50 to 70 nm, is used as a raw material. In this comparative example, the carbon nano fiber is prepared by the thermal CVD of acetylene using an iron platinum microparticle as a catalyst. The oxygen reduction activity of the obtained carbon material is as low as ½ or less compared with Example 1.

### EXAMPLE 2

The carbon material is prepared in the same manner as in Example 1 except that the amount of potassium permanganate is 1.5 times that of Example 1. The number of nitrogen atoms, oxygen atoms, and manganese atoms, which are observed by the XPS measurement of the carbon material, is 5%, 4%, and 0.05%, respectively, with respect to the number of carbon atoms. With the respect to the obtained carbon material, an oxygen reduction current is about 1.5 times that of Example 1, and the activity is higher.

### EXAMPLE 3

The carbon material obtained by Example 1 carries on 0.2 wt % platinum microparticle having the diameter of 1 to 3 nm using sodium boro hydrate as a reducing agent in an aqueous chloroplatinic acid solution. With the respect to the obtained catalyst, an oxygen reduction starting potential is positive-side compared with Example 1, the amount of current is also higher, and the activity is higher. In addition, an initial current value is lowered to about 10% even after the potential of 1.0 to 1.5 V is repeated 500 times, resulting in a stable state.

### COMPARATIVE EXAMPLE 3

A platinum carried catalyst is prepared in the same manner as in Example 3 except for using the carbon material obtained by Comparative Example 1. The oxygen reduction activity is the same as Example 3, but the initial current value is lowered to about a half in the case in which the potential of 1.0 to 1.5 V is repeated 500 times.

### EXAMPLE 4

The fuel cell is prepared using the carbon material obtained by Example 1 as a positive electrode catalyst. An oxygen reduction catalyst layer obtained by mixing the oxygen reduction catalyst, the carbon fiber, and Nafion is formed on a gas diffusion layer. The carried amount of the oxygen reduction catalyst is 5 mg/cm². A hydrogen oxidation catalyst of the negative electrode side uses TEC10E30E (manufactured by Tanaka Precision Metals CO., Ltd.), and the electrolyte membrane uses NRE211CS (manufactured by DuPont). The amount of platinum of the negative electrode side is 0.05 mg/cm². The positive electrode and the negative electrode are integrated with the electrolyte membrane by a thermo-compression. The fuel cell is formed by contacting a carbon paper as a gas diffusion layer. A hydrogen gas, which is 100% RH in humidity, is provided at the negative electrode side of the fuel cell, and the air, which is 100% RH in humidity, is provided at the positive electrode side. Then, the electrochemical reaction occurs in an electronic load device. The obtained fuel cell has also excellent characteristics of start/stop cycles with high-power.

### COMPARATIVE EXAMPLE 4

The fuel cell is prepared in the same manner as in Example 3 except for using the carbon material obtained by Comparative Example 1. The obtained fuel cell is small in power compared with Example 3.

### EXAMPLE 5

The oxygen decreasing cell is prepared using the carbon material obtained by Example 2 as a negative electrode catalyst. The oxygen reduction catalyst layer obtained by mixing the oxygen reduction catalyst, the carbon fiber, and Nafion is formed on the gas diffusion layer. The carried amount of the oxygen reduction catalyst is 5 mg/cm². An iridium oxide hydrolysis catalyst is used as the positive electrode, and the carried amount is 1 mg/cm². The electrolyte membrane uses NRE211CS (manufactured by DuPont). The positive electrode and the negative electrode are integrated with the electrolyte membrane by the thermo-compression. The oxygen decreasing cell is formed by contacting the carbon paper as a gas diffusion layer. Liquid water is provided at the positive electrode side of the oxygen decreasing cell, the negative electrode side is connected to a closed space of 10 L, and the oxygen concentration of the closed space decreases to 15% by the operation at a current density of 0.1 A/cm². Then, the oxygen concentration is returned by the introduction of the outside air. The obtained oxygen decreasing cell has also excellent characteristics of operating cycles.

### COMPARATIVE EXAMPLE 5

The oxygen decreasing cell is prepared in the same manner as in Example 4 except for using the carbon material obtained by Comparative Example 1. The obtained oxygen decreasing cell requires a high voltage in the operation at the current density of 0.1 A/cm² and is faster than twice in deterioration rate.

### EXAMPLE 6

A dehumidification cell is prepared using the carbon material obtained by Example 1 as a negative electrode. The oxygen reduction catalyst layer obtained by mixing the oxygen reduction catalyst, the carbon fiber, and Nafion is formed on the gas diffusion layer. The carried amount of the oxygen reduction catalyst is 5 mg/cm². An iridium oxide is used as the positive electrode, and the electrolyte membrane uses NRE211CS (manufactured by DuPont). The positive electrode and the negative electrode are integrated with the electrolyte membrane by the thermo-compression. The dehumidification cell is formed by contacting the carbon paper as a gas diffusion layer. The positive electrode side of the dehumidification cell is connected to the closed space of 10 L, and the relative humidity of the closed space decreases to 30% by the operation at the current density of 0.02 A/cm². Then, the relative humidity is returned by the introduction of the air having the relative humidity of 80%. The obtained dehumidification cell has also excellent characteristics of operating cycles.

### EXAMPLE 7

The lithium ion secondary battery is prepared using the carbon material obtained by Example 1 as a negative electrode.

A solution is formed by mixing 20 g of tetraethoxysilane with 50 g of ethanol in a beaker placed in an ice-water bath. After then, 5 g of Si particles having an average particle diameter of 60 nm and 5 g of a carbon material obtained by Example 1 are mixed with this solution together with 120 g of a 5% ammonia water. The mixed solution is stirred and mixed in an oil bath of 80° C. for three hours and is then cooled to room temperature with stirring to obtain a coating solution.

A slurry-like coating solution is coated on a copper foil for current collector with a doctor blade-type applicator under a gap condition of 50 μm and is then dried at 150° C. for one hour in the atmosphere. After the drying, the film thickness is adjusted with a roll press so as to become 15 μm. Further, a carbon film of 1 μm in thickness is formed, as a conductive layer, on the above film by a sputtering to obtain the negative electrode for the lithium ion secondary battery.

The lithium ion secondary battery is made up of the negative electrode, LiPON solid electrolyte, and a Li metal foil reference electrode. It is carried out by measuring an initial discharge capacity and a discharge capacity after charging and discharging of 50 cycles and calculating a maintenance ratio of discharge capacity. The discharge capacity is set such that a design value becomes 1200 mAh/g based on an effective active material Si. First, the charge is carried out under the condition of a constant-current/constant-voltage in the environment of 25° C. until a current value becomes 0.2 C and a voltage value becomes 0.02 V, and the charge is stopped at the time that the current value is dropped to 0.05 C. After then, the discharge is carried out under the condition of 0.2 C in current value until the voltage to the Li metal becomes 1.5 V to measure the discharge capacity with respect to the current value of 0.2 C. Furthermore, the current value capable of being fully charged for one hour is referred to as “1 C”. In addition, both of the charging and the discharging were carried out in the environment of 25° C. Then, the charging and discharging of 50 cycles were repeated at charge/discharge rate in the current value of 0.2 C. A ratio of the discharge capacity, when the charging and discharging of 50 cycles are repeated, to the initial discharge capacity with respect to the current value of 0.2 C is calculated as a percentage. The capacity maintenance rate is 95% or more, and thus the cycle characteristics are excellent.

### COMPARATIVE EXAMPLE 6

The lithium ion secondary battery is prepared in the same manner as in Example 7 except for using carbon material obtained by Comparative Example 2. The obtained lithium secondary battery is 50% or less in capacity maintenance rate and is thus inferior in cycle characteristics.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A carbon material comprising a columnar structure in which a carbon compound having a graphene skeleton is laminated, the graphene skeleton whose some of carbon atoms are substituted with nitrogen atoms,
wherein, a graphene skeleton surface of the carbon compound is inclined at an angle of 5 degrees or more and 80 degrees or less with respect to a column axial direction of the columnar structure.

2. The carbon material according to claim 1, wherein the graphene skeleton surface of the carbon compound is inclined at an angle between 10 degrees or more and 60 degrees or less with respect to the column axial direction of the columnar structure.

3. The carbon material according to claim 1, wherein the ends of the columnar structure include a hollow structure having a recess.

4. The carbon material according to claim 1, wherein a compound, in which the graphene skeleton surface of the carbon compound is inclined at an angle between 5 degrees or more and 80 degrees or less with respect to the column axial direction of the columnar structure, is not less than 5% and not more than 90% of the carbon compound.

5. The carbon material according to claim 1, wherein a diameter of the columnar structure is in a range of 30 nm to 500 nm.

6. The carbon material according to claim 1, wherein oxygen atoms are bonded to some of carbon atoms of the graphene skeleton.

7. The carbon material according to claim 1, further comprising at least one of:
at least one metal particle selected from iron, cobalt, manganese and platinum;
at least one metal ion selected from iron, cobalt, and manganese; and
at least one phosphorus compound selected from monophosphate, origophosphate, or polyphosphoric acid.

8. A method of manufacturing a carbon material, comprising:
dissolving the metal particle which is contained in a carbon fiber having a structure in which graphene surfaces are overlapped; and
substituting some of carbon atoms with nitrogen atoms after the dissolving of the metal particle.

9. The method according to claim 8, wherein the substituting of the some of carbon atoms with the nitrogen atoms is carried out by performing treatment on the carbon fiber with an acidic solution containing potassium permanganate, and after the treatment, treating the carbon fiber using hydrazine or ammonia, and heating the carbon fiber.

10. An electrochemical cell comprising:
a positive electrode;
a negative electrode; and
an electrolyte configured to be sandwiched between the positive electrode and the negative electrode,
wherein the positive electrode or the negative electrode contains a carbon material, which includes a columnar structure in which a carbon compound having a graphene skeleton is laminated, the graphene skeleton whose some of carbon atoms are substituted with nitrogen atoms, and
a graphene skeleton surface of the carbon compound is inclined at an angle of 5 degrees or more and 80 degrees or less with respect to a column axial direction of the columnar structure.

11. The electrochemical cell according to claim 10, wherein the electrochemical cell is used for a fuel cell, an oxygen decreasing cell, a dehumidification cell, a water electrolysis cell, or a lithium ion secondary battery.

12. The electrochemical cell according to claim 10, wherein the graphene skeleton surface of the carbon compound is inclined at an angle between 10 degrees or more and 60 degrees or less with respect to the column axial direction of the columnar structure.

13. The electrochemical cell according to claim 10, wherein the ends of the columnar structure include a hollow structure having a recess.

14. The electrochemical cell according to claim 10, wherein a compound, in which the graphene skeleton surface of the carbon compound is inclined at an angle between 5 degrees or more and 80 degrees or less with respect to the column axial direction of the columnar structure, is not less than 5% and not more than 90% of the carbon compound.

15. The electrochemical cell according to claim 10, wherein a diameter of the columnar structure is in a range of 30 nm to 500 nm.

16. The electrochemical cell according to claim 10, wherein oxygen atoms are bonded to some of carbon atoms of the graphene skeleton.

17. The electrochemical cell according to claim 10, further comprising at least one of:
at least one metal particle selected from iron, cobalt, and manganese;
at least one metal ion selected from iron, cobalt, and manganese;
at least one phosphorus compound selected from monophosphate, origophosphate, or polyphosphoric acid; or
a platinum particle in the carbon material.

18. The electrochemical cell according to claim 10, further comprising a silicon particle in the negative electrode, wherein the electrochemical cell is used for a lithium secondary battery.
